(19) United States
(12) Patent Application Publication
(10) Pub. No.: US 2016/0095046 A1
(43) Pub. Date: Mar. 31, 2016

(54) Method and Apparatus for Use in Network Selection

(71) Applicant: NOKIA SOLUTIONS AND NETWORKS OY, Espoo (FI)

(72) Inventors: Janne Petteri TERVONEN, Espoo (FI); Woonhee HWANG, Espoo (FI); Hanns Juergen SCHWARZBAUER, Grobenzell (DE)

(21) Appl. No.: 14/888,501

(22) PCT Filed: May 3, 2013
(86) PCT No.: PCT/EP2013/059202

§ 371 Date: Nov. 2, 2015

(51) Int. Cl. H04W 48/08; H04W 76/04; H04W 76/02; H04W 48/18

(52) U.S. Cl. CPC H04W 48/08; H04W 48/18; H04W 76/046; H04W 76/027

(57) ABSTRACT

A method includes causing a user equipment to use one or more wireless local area networks based on cellular network information for a wireless cellular network indicating that a user equipment has restricted access to said wireless cellular network.

This disclosure relates to a method and apparatus and in particular but not exclusively to method and apparatus for use in network selection.

A communication system can be seen as a facility that enables communication sessions between two or more entities such as fixed or mobile communication devices, base stations, servers, machine type communication devices and/or other communication nodes. A communication system and compatible communicating entities typically operate in accordance with a given standard or specification which sets out what the various entities associated with the system are permitted to do and how that should be achieved. For example, the standards, specifications and related protocols can define the manner how various aspects of communication such as access to the communication system and feedback messaging shall be implemented between communicating devices. The various development stages of the standard specifications are referred to as releases.

A communication can be carried on wired or wireless carriers. In a wireless communication system at least a part of communications between stations occurs over a wireless link. Examples of wireless systems include public land mobile networks (PLMN) such as cellular networks, satellite based communication systems and different wireless local networks, for example wireless local area networks (WLAN, also referred to as Wi-Fi). A wireless system can be divided into cells or other radio coverage or service areas provided by a station. Radio service areas can overlap, and thus a communication device in an area can send and receive signals within more than one station. Each radio service area is controlled by an appropriate controller apparatus. Higher level control may be provided by another control apparatus controlling a plurality of radio service area.

A wireless communication system can be accessed by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication device such as e.g. a base station and/or another user equipment.

Wi-Fi networks are becoming an integrated part of mobile broadband. Wi-Fi is a standard feature on some phones such as smart phones, tablets and laptops.

According to an embodiment, there is provided a method comprising: causing a user equipment to use one or more wireless local area networks based on cellular network information for a wireless cellular network indicating that a user equipment has restricted access to said wireless cellular network.

The network information may be received from said wireless cellular network if the method is performed in an apparatus of a user equipment.

The cellular network information may be sent from an entity of said wireless cellular network if the method is performed in an apparatus of said entity.

The cellular network information may comprise network performance information.

The restricted access may comprise at least one of barring of said user equipment and rejection of a connection.

The barring may comprise at least one of barring of said user equipment for data, signalling, emergency calls and priority calls.

The rejection may comprise rejection of a radio resource control connection

The method may comprise using one or more rules defining how said user equipment is to behave in response to restricted access to said wireless cellular network.

The method may comprise receiving said one or more rules if the method is performed in an apparatus of a user equipment. The method may comprise transmitting said rules if the method is performed in an apparatus of an entity of the wireless cellular network.

At least one rule may define a response when a particular restricted access condition occurs.

One or more rules may be dependent on a subscription class of said user equipment

The method may comprise receiving at least part of one or more rules as part of one or more access network discovery and selection function policies. This may be the case where the method is performed in an apparatus of a user equipment.

The method may comprise transmitting at least part of one or more rules as part of one or more access network discovery and selection function policies. This may be the case where the method is performed in in an apparatus of an entity of the wireless cellular network.

The access network discovery and selection function policy may comprise at least one access network discovery and selection function value associated with restricted access to said wireless cellular network. In some embodiments, the value is a priority value. In some embodiments, usage of said value when said there is restricted access is defined. An access network discovery and selection function policy management object may comprise said value. The management object may be access network discovery and selection function policy mobility operator access network priority.

The method may comprise receiving at least part of one or more rules in one or messages from said cellular network. This may be the case where the method is performed in an apparatus of a user equipment.

The method may comprise transmitting at least part of one or more rules in one or messages from said cellular network. This may be the case where the method is performed in in an apparatus of an entity of the wireless cellular network.

The method may comprise using information about one or more wireless local area networks to select the one or more wireless local area networks to be used by said user equipment. The using may be an apparatus of a user equipment. The method may comprising providing information about one or more wireless local area networks from which the one or more wireless local area networks to be used by said user equipment is selectable. This may be the case where the method is performed in in an apparatus of an entity of the wireless cellular network.

The information about said one or more wireless local area networks may comprise identity information for said one or more wireless local area networks.

The identity information may comprise service set identifier information.

The method may be performed by an apparatus. The apparatus may be a radio access network entity.

According to another embodiment, there is provided an apparatus comprising at least one processor and at least one memory including computer code for one or more programs, the at least one memory and the computer code configured, with the at least one processor, to cause the apparatus at least to: cause a user equipment to use one or more wireless local area networks based on cellular network information for a wireless cellular network indicating that a user equipment has restricted access to said wireless cellular network.

The at least one memory and the computer code may be configured, with the at least one processor, to cause the apparatus to receive the network information from said wireless cellular network if the apparatus is for a user equipment.

The at least one memory and the computer code may be configured, with the at least one processor, to cause the apparatus to transmit the cellular network information if the apparatus is for an entity of said wireless cellular network.

The cellular network information may comprise network performance information.

The restricted access may comprise at least one of barring of said user equipment and rejection of a connection.

The barring may comprise at least one of barring of said user equipment for data, signalling, emergency calls and priority calls.

The rejection may comprise rejection of a radio resource control connection

The at least one memory and the computer code may be configured, with the at least one processor, to cause the apparatus to use one or more rules defining how said user equipment is to behave in response to restricted access to said wireless cellular network.

The at least one memory and the computer code may be configured, with the at least one processor, to cause the apparatus to receive said one or more rules. This may be where the apparatus is for a user equipment.

The at least one memory and the computer code may be configured, with the at least one processor, to cause the apparatus to transmit said rules. This may be where the apparatus is for an entity of the wireless cellular network.

At least one rule may define a response when a particular restricted access condition occurs.

One or more rules may be dependent on a subscription class of said user equipment

The at least one memory and the computer code may be configured, with the at least one processor, to cause the apparatus to receive least part of one or more rules as part of one or more access network discovery and selection function policies.

The access network discovery and selection function policy may comprise at least one access network discovery and selection function value associated with restricted access to said wireless cellular network. In some embodiments, the value is a priority value. In some embodiments, usage of said value when said there is restricted access is defined. An access network discovery and selection function policy management object may comprise said value. The management object may be access network discovery and selection function policy mobility operator access network priority.

The at least one memory and the computer code may be configured, with the at least one processor, to cause the apparatus to receive at least part of one or more rules in one or messages from said cellular network. This may be the case where the apparatus is for a user equipment.

The at least one memory and the computer code may be configured, with the at least one processor, to cause the apparatus to transmit at least part of one or more rules in one or messages from said cellular network. This may be the case where the apparatus is an entity of the wireless cellular network.

The at least one memory and the computer code may be configured, with the at least one processor, to cause the apparatus to use information about one or more wireless local area networks to select the one or more wireless local area networks to be used by said user equipment. This may be the case where the apparatus is for a user equipment.

The at least one memory and the computer code may be configured, with the at least one processor, to cause the apparatus to provide information about one or more wireless local area networks from which the one or more wireless local area networks to be used by said user equipment is selectable. This may be the case where the apparatus is an entity of the wireless cellular network.

The information about said one or more wireless local area networks may comprise identity information for said one or more wireless local area networks.

The identity information may comprise service set identifier information.

The apparatus may be in a user equipment or a radio access network entity. According to an embodiment, there is provided an apparatus comprising; means for causing a user equipment to use one or more wireless local area networks based on cellular network information for a wireless cellular network indicating that a user equipment has restricted access to said wireless cellular network.

The apparatus may comprise means for receiving the network information from said wireless cellular network if the apparatus is for a user equipment.

The apparatus may comprise means for transmitting the cellular network information if the apparatus is for an entity of said wireless cellular network.

The cellular network information may comprise network performance information.

The restricted access may comprise at least one of barring of said user equipment and rejection of a connection.

The barring may comprise at least one of barring of said user equipment for data, signalling, emergency calls and priority calls.

The rejection may comprise rejection of a radio resource control connection

The apparatus may comprise means for using one or more rules defining how said user equipment is to behave in response to restricted access to said wireless cellular network.

The apparatus may comprise means for receiving said one or more rules. This may be where the apparatus is for a user equipment.

The apparatus may comprise means for transmitting said one or more rules. This may be where the apparatus is for an entity of the wireless cellular network.

At least one rule may define a response when a particular restricted access condition occurs.

One or more rules may be dependent on a subscription class of said user equipment

The apparatus may comprise means for receiving at least part of one or more rules as part of one or more access network discovery and selection function policies.

The access network discovery and selection function policy may comprise at least one access network discovery and selection function value associated with restricted access to said wireless cellular network. In some embodiments, the value is a priority value. In some embodiments, usage of said value when said there is restricted access is defined. An access network discovery and selection function policy management object may comprise said value. The management object may be access network discovery and selection function policy mobility operator access network priority.

The apparatus may comprise means for receiving at least part of one or more rules in one or messages from said cellular network. This may be the case where the apparatus is for a user equipment.

The apparatus may comprise means for transmitting at least part of one or more rules in one or messages from said cellular network. This may be the case where the apparatus is an entity of the wireless cellular network.

The information about said one or more wireless local area networks may comprise identity information for said one or more wireless local area networks.

The identity information may comprise service set identifier information.

The apparatus may be in a user equipment or a radio access network entity.

A computer program comprising program code means adapted to perform the method(s) may also be provided. The computer program may be stored and/or otherwise embodied by means of a carrier medium.

In the above, many different embodiments have been described. It should be appreciated that further embodiments may be provided by the combination of any two or more of the embodiments described above.

Various other aspects and further embodiments are also described in the following detailed description and in the attached claims.

Embodiments will now be described in further detail, by way of example only, with reference to the following examples and accompanying drawings, in which:

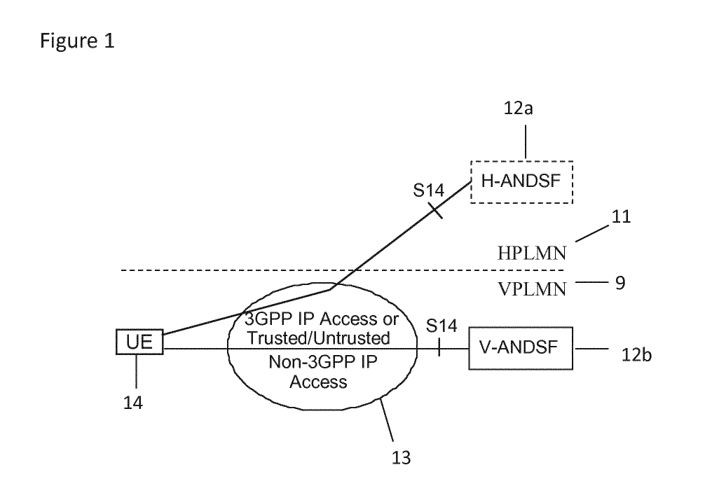

FIG. 1 shows a schematic diagram of an ANDSF (access network discovery and selection function) architecture;

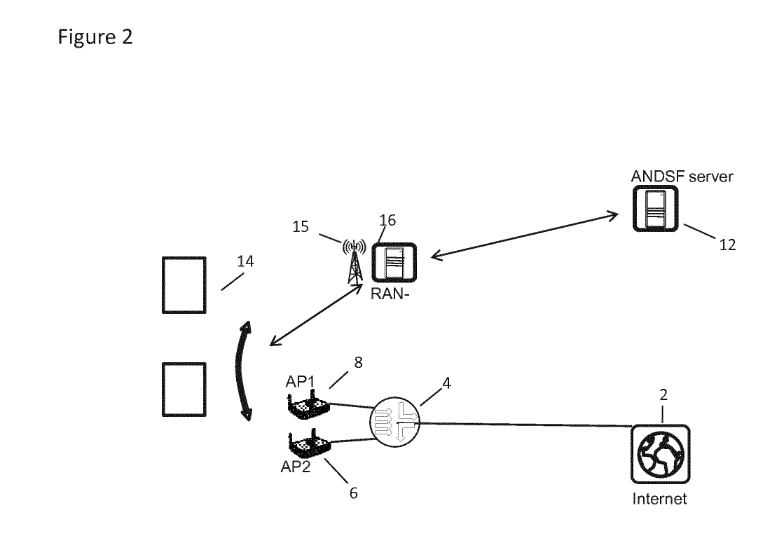

FIG. 2 shows an architecture with a WLAN and a wireless cellular network;

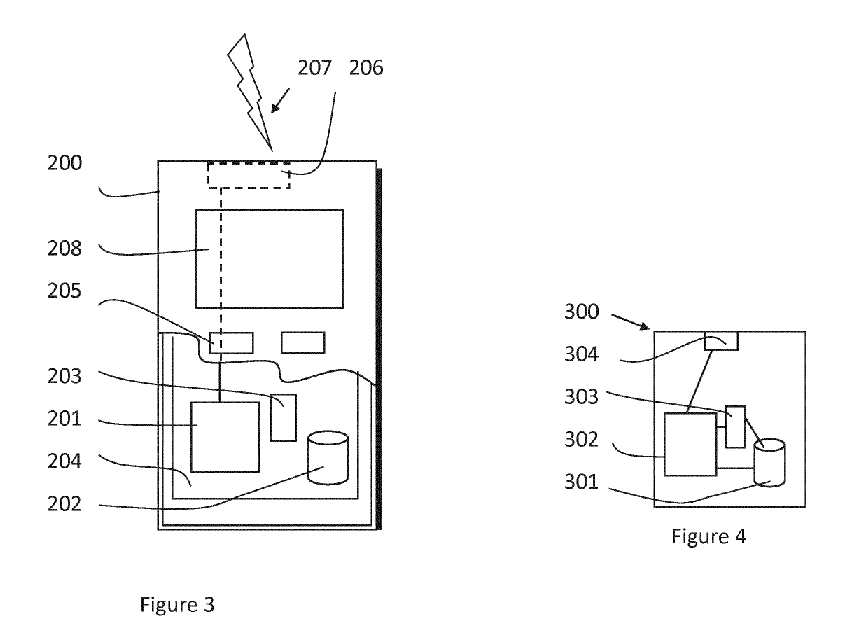

FIG. 3 shows a user equipment;

FIG. 4 shows a control apparatus; and

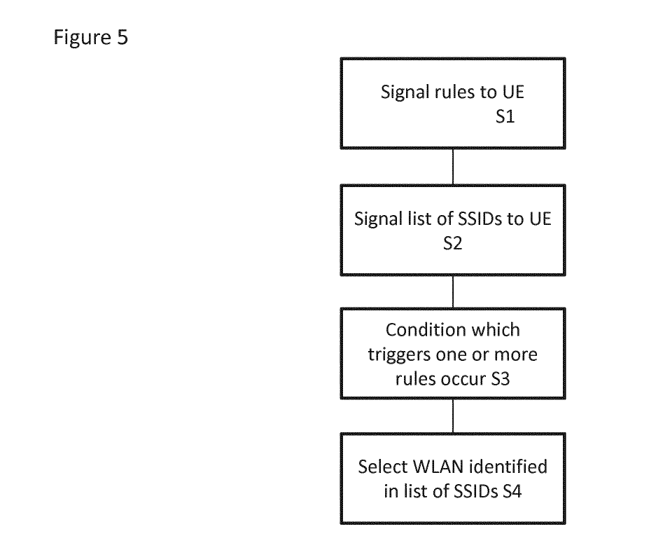

FIG. 5 shows a method of an embodiment.

Wi-Fi networks are in some places becoming an integral part of mobile broadband. Wi-Fi is a standard feature on some smart phones, tablets and laptops. Some operators are using or planning to use Wi-Fi alongside mobile radio access networks. As Wi-Fi becomes just another cell alongside mobile radio access networks, some operators need to control how the user device or user equipment moves between the mobile and Wi-Fi networks.

Mobile network operators are thus using cellular offloading to (carrier/third parties) Wi-Fi networks for capacity and coverage purposes. The use of Wi-Fi networks may be inexpensive in terms of licensing for spectrum and/or for cost of deployment). Wi-Fi networks may offer good network performance in high-traffic urban environments.

Furthermore, even without any operator control, today's subscribers simply disappear from cellular networks to connect to the user's preferred access points whenever these are available, e.g. at home or in the work place. That is because Wi-Fi network discovery, selection and access is terminal implementation specific and may further be user-controlled via a connection manager utility installed at the client side. This may provide ad-hoc connectivity.

Reference is made to FIG. 1 which schematically shows Access Network Discovery and Selection Function (ANDSF, TS 3GPP 23.402, 3GPP TS 24.302, 3GPP TS 24.312) to assist UEs to perform network discovery and selection including 3GPP and non 3GPP access.

In the arrangement of FIG. 1, a H-ANDSF (Home ANDSF) 12a associated with the home network 11 (for example a HPLMN—home public land mobile network) of the UE 14 is provided. A V-ANDSF (Visited-ANDSF) 12b associated with a network visited (for example a VPLMN—visited public land mobile network) by the UE is provided. The UE and the respective ANDSF entities communicate via either a 3GPP IP access or a non 3GPP IP access 13. The 3GPP IP access can be trusted or untrusted. The interface between the IP access and the respective ANDSF may be an IP based interface.

In some embodiments, OMA DM (object management architecture device management) may be used by the ANDSF as the protocol and information standard.

Location and UE specific provisioning from the ANDSF to the UE may comprise one of more of the following information: a per subscriber level list of the available RATs (radio access technologies) in the vicinity and optionally their priority (for example this may be in the form of a location-aware coverage map and access policy); and policy validity of time interval (this may be in the form of a time-based policy).

The ANDSF 12a or 12b responds to UE requests for access network discovery information (pull mode). In some embodiments, the ANDSF may be able to initiate data transfer to the UE (push mode). This may be based on network triggers or as a result of a previous communication with the UE (hybrid pull-push operation).

In the pull mode, a UE will discover the ANDSF. The UE will contact the ANDSF to request policy information. The UE will interpret and act on the policy.

In the push mode, the policy is pushed to the UE. This may be achieved using SMS (short message service), or any other available push mechanism. The push mode may provide full information or may result in the UE contacting the ANDSF or more information. In the latter case, the push mode may be a trigger to enter a pull mode.

3GPP Rel-10/11 have introduced features such as S2a based Mobility over GPRS (General Packet Radio service) Tunnelling Protocol (GTP) (SaMOG), Multiple Connections via 3GPP and non-3GPP access (MAPCON), IFOM (IP Flow Mobility), advanced policy control with Access Network Discovery and Selection Function (ANDSF) which allows enhanced offloading control at Packet Data Network (PDN) granularity (for MAPCON) or at IP flow granularity (for IFOM and non-seamless offload).

ANDSF allows the operator to influence what WLAN networks the UE uses, when and at which locations. Being based on Open Mobile Alliance (OMA) Device Management (DM) framework, ANDSF is often not very suitable for dynamic operations. Currently ANDSF access policies are static. In other words, the ANDSF policies are not responsive to the dynamic behavior of real-time network load conditions. ANDSF provides static network selection policies that are updated not very often, e.g. once a month.

The ANDSF policies do not account for factors such as target QoS or load/congestion which would make some WLAN access/node more desirable than others in given geographical area. Given the static conditions for the ANDSF access policies, there will be a tendency towards static offloading. This is because currently the parameters do not provide options to balance the triggers for when to access one type of node and when to access other type such as when balancing load between Wi-Fi and 3GPP technologies. Thus at the moment ANDSF alone cannot currently be used to guide UE to a WLAN in real time.

Currently ANDSF can provide the network policy for selecting the WLAN network. This may be based on for example SSIDs (service set identifiers) and their priorities. ANDSF can define one or more of: a priority per WLAN network; if a UE has restricted access to the WLAN network; and if a WLAN network is forbidden for the UE. However, UE action can depend on UE implementation. Some cellular operators want to have more control over WLAN access. For instance, operators may want to preferably avoid using some SSIDs as long as cellular coverage is provided. For example if a cellular network operator has a roaming agreement with WLAN providers and cellular network operator does not own the WLAN APs, keeping the UEs in the cellular network may cost less for the cellular operators. However, currently there is no mechanism to handle this kind of situation.

Reference is made to FIG. 2 which shows an example of a high level network architecture with an ANDSF server. The system shown in FIG. 2 comprises user equipment 14. The user equipment is arranged to be able to connect to a first access point or a second access point 6 or 8. As an example, the access points 6 and 8 are connected to a router 4 which permits connection to the Internet 2. The access points 6 and 8 along with the router 4 can be considered to provide the Wi-Fi function. The access points may be part of a WLAN. In some embodiments, the access points may belong to different WLANs. In practice, there are multiple deployment possibilities for WLAN/Wi-Fi. In operator cases, there may be a WLAN Controller to which access are connected. The WLAN Controller is then attached to operator backbone, in practice at least to a router providing access to the Internet.

The user equipment 14 is also arranged to an access node 15 of a radio access network. The access node 15 may be a base station, node B or the like. Also provided is a RAN controller 16, in some embodiments. The RAN is made up of the base station or node B and the controller. In some embodiments, the controller and the access node may be provided by a common entity such as an eNodeB B.

Also shown is an ANDSF server 12 which as discussed in relation to FIG. 1 is connected using either a 3GPP or non 3GPP IP access to the UE. The ANDSF server may be used to provide overall and fixed network selection policies to a user device. These policies may include for example the roaming partner Wi-Fi networks the user device should utilize when available, overall network selection policies for operator hotspots, and default network discovery and selection rules for the UE. In some embodiments there may be one or more ANDSF servers. In some embodiments, some or all of the ANDSF functionality may be provided by a server locally.

A possible mobile communication device suitable for implementing some embodiments will now be described in more detail in reference to FIG. 3 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air interface 207 via appropriate apparatus for receiving and may transmit signals via appropriate apparatus for transmitting radio signals. In FIG. 3 transceiver apparatus is designated schematically by block 206. The transceiver apparatus 206 may be provided for example by means of a radio part and associated antenna arrangement.

A mobile device is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices can access the communication system based on various access techniques, such as 3GPP standardized long term evolution (LTE), code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and no on. Some communication devices can in addition also access local area or wide area communications systems based on various non-3GPP standardized access techniques such as wireless local area network (WLAN, Wi-Fi) and/or WiMax (Worldwide Interoperability for Microwave Access) and/or HRPD (High Rate Packet Data, commonly known as 1xEV-DO).

A non-limiting example of the recent developments in communication system architectures is the long-term evolution (LTE) of the Universal Mobile Telecommunications System (UMTS) that is being standardized by the 3rd Generation Partnership Project (3GPP). As explained above, further development of the LTE is referred to as LTE-Advanced. Non-limiting examples of appropriate LTE access nodes are a base station of a cellular system, for example what is known as NodeB (NB) in the vocabulary of the 3GPP specifications. The LTE employs a mobile architecture known as the Evolved Universal Terrestrial Radio Access Network (E-UTRAN). Base stations of such systems are known as evolved or enhanced Node-Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices.

One or more entities of the RAN may be provided with a control apparatus. FIG. 4 shows an example of a control apparatus. The control apparatus 400 can be configured to provide control functions. For this purpose the control apparatus 400 comprises at least one memory 301, at least one data processing unit 302, 303 and an input/output interface 304. Via the interface the control apparatus can be coupled to receive information and/or commands and/or provide as output information and/or commands. The control apparatus 400 can be configured to execute an appropriate software code to provide the control functions.

In other embodiments, alternatively or additionally ANDSF related functionality may be placed elsewhere in the network, such as the packet core and P-GW/DPI (Packet gateway/Deep Packet Inspection or PCRF (Policy and Charging Rules Function, like PCRF-ANDSF).

In some embodiments, typically, if the cellular network is overloaded, operators started to bar access using the access class barring mechanism in the cellular network. Alternatively or additionally a RRC (radio resource control) Connection can be rejected by a network controller. (e.g., an eNB and/or RNC)

In some embodiments, a UE will behave in accordance with one or more specific rules. The one or more rules may be signalled to UE. Alternatively or additionally, the eNodeB may control the UE to behave in accordance with the one or more specific rules. Alternatively or addition, one or more rules may be fixed and the UE may operate in accordance with the rules.

The one or more rules may be provided in ANDSF policy and/or by a message in the cellular network.

The one or more rules may be provided by the ANDSF server, the eNB or by a fixed rule.

By way of example, the rules may comprise one or more of the following.
If the UE is barred for MO (mobile originated)-data, the UE is allowed to access a certain list of one or more WLAN networks.
If the UE is barred for MO-signalling. UE is allowed to access certain list of one or more WLAN networks.
If emergency call is barred, the UE is allowed to access certain list of one or more WLAN networks
if priority call is barred, the UE is allowed to access certain list or one or more WLAN networks
If an RRC Connection is rejected, the UE is allowed to access certain list of one or more WLAN networks
If an RRC Connection is rejected with deprioritization, a UE is allowed to access certain list of one or more WLAN networks. In RRC messaging, an eNB can reject the RRC Connection Request and de-prioritize the current frequency or RAT for a certain duration.

In some embodiments, a combination of one or more of the above rules can be provided

In some embodiments, the one or more rules provided may depend on the subscription on the UE. For example gold users can apply one or more particular rules while silver or bronze users cannot apply those particular one or more rules.

The list of one or more WLAN networks and the one or more rules may be provided to the UE from the cellular network. In some embodiments, the information may be provided by the base station. The list of one or more WLAN networks may be defined by one or more of an ANDSF server, OMA DM, a UE configuration server or by any other suitable entity.

Some embodiments, may define the usage of the “Restricted access” value of a ANDSF MO AccessNetworkPriority leaf when certain information is received from a cellular network, e.g. UE is barred for MO-data. The restricted access value is controlled by the ANDSF server. ANDSF MO AccessNetworkPriority leaf is one part of the ANDSF management object as specified in 3GPP TS 24.312. This embodiment may use an existing ANDSF MO. As an alternative to the “restricted access value” a new value from one of the reserved values from ANDSF MO AccessNetworkPriority may be used. It should be appreciated that additionally or alternatively, any other suitable ANDSF management object may be used in some embodiments.

Alternatively or additionally, in some embodiments a list of the one or more WLAN networks and the rule are provided as a part of ANDSF policy. The cellular information may be used as an indicator to select a certain ANDSF policy. For example when a cell indicates a UE is barred for MO-data, a specific ANDSF policy, is used, when an emergency call is barred another ANDSF policy, may be used. In this regard, the cellular network may signal the UE, in usage of ANDSF policies, for example, about cellular network performance information such as existing cellular indications of load condition such as MO-data barred and/or MO-signalling barred in the cellular network. In response, the UE may be triggered or guided to initiate or start Wi-Fi offloading or may be forced to stay in the cellular work based on the cellular network performance information such as specific cellular network performance problems reported or signalled in the cellular network. In other words, the cellular network may utilize cellular network performance information such as various network congestion problems occurring in the cellular network to push or guide the UE towards the WLAN network without considering WLAN performance or WLAN conditions on load or performance. In addition, the UE may conduct one or more different reactions in response to various specific cellular network performance problems reported or signalled in the cellular network.

Alternatively, or additionally a cellular network can provide the necessary information in the system information sent to the UE by the base station. The information may be broadcast and/or provided in a dedicated message to UE.

Alternatively, or additionally, the information may provide using both ANDSF policy and the cellular network. If information from the ANDSF and cellular network overlap/conflict, in some embodiments, the information received from cellular network takes precedence.

In some embodiments, one or more of the following can be options.

Define in the ANDSF specification that ANDSF MO AccessNetworkPriority leaf value “Restricted access” is used together with cellular network barring information in such a way that when UE receives one of cellular network barring information the UE is permitted to start using a WLAN network with “Restricted access” as the AccessNetworkPriority value, The cellular network barring information may be for example UE barred for MO-data. UE barred for MO-signalling, or emergency calls are barred. When the cellular network does not broadcast any barring information the UE is not allowed to use the WLAN networks with “Restricted access” as AccessNetworkPriority value.

Some embodiments may alternatively or additionally define new values for AccessNetworkPriority leaf from the Reserved value space. For example, there may be specific values for each of one or more cellular network barring information.

In some embodiments ANDSF policy may be tagged with information telling when the policy is applicable related to the cellular network condition. This may be any suitable condition and may for example include any of the conditions mentioned previously.

In some embodiments a bitmap can be defined to enable more than one options being active at the same time, for example the UE barred for MO-data AND MO-signalling, etc. The bitmap may be defined in the cellular signalling from the eNB to the UE or in the ANDSF. In some embodiments, a new leaf may be added into the ANDSF MO structure under ISMP (Inter system mobility policy) and/or ISRP (Inter system routing policy) and/or IARP (Inter-APN Routing Policy).

In some embodiments, alternatively or additionally the selection rules of one or more active ANDSF rules may be modified.

In some embodiments, the UE knows what policy to activate based on applicability information from cellular network. This applicability information may be any barring or rejection information such as discussed previously.

In some embodiments, a message in the cellular network delivers the list of one or more SSIDs that could be used for a certain case or cases. In one embodiment, this information can be signalled when cellular network access is not possible (e.g., when access barring is activated) or can be pre-configured with a dedicated message. The list of one or more SSIDs could be broadcasted in SIBs (system information broadcasts), in which case the information is applicable for all UEs hearing this information.

Alternatively, the list of SSIDs can be included in a signalling message, e.g. in RRC Connection Reject message or in RRC Connection Release message or any other dedicated RRC message, thus making it possible to deliver different information for different UEs/subscribers based on subscriber class, etc. differentiation. For instance a gold user can have the list of SSIDs which can be used while the access to the cell is impossible while bronze user will not receive this list.

If the UE receives such a list of prioritized SSIDs, the UE assumes that the information is valid until it hears new information from the network and/or while a validity timer is running.

In some embodiments a cellular operator may not want to insert a long list of SSIDs into SIBs or signalling messages. Accordingly the SSID list may have only a few entries. The number of entries may depend on the operator deployment: in the simplest case there could be e.g. one SSID for normal operation and another SSID to relieve cellular congestion, so the number of entries may be two, as an example. Of course, it is possible to have more SSIDs, but if the different SSIDs are running in the same physical APs, there may only be a few different SSIDs (e.g. 2-4) since each new SSID will consume the overall capacity from the actual data transfer. In some embodiments, the goal may to minimize the number of SSIDs in a single AP. On the other hand, SSIDs can also be used to differentiate subscribers by allocating different classes, for example some to SSID_gold, and some others to SSID_bronze, as an example. In some embodiments, it may be possible to have different bitrate capabilities defined for each SSID. The number of SSIDs per AP is a balancing task for the operator. The above described options are by way of example only.

In some embodiments any other suitable WLAN network identification or access point identification can also be used. For example, some other identifiers such as HESSID (Homogeneous Extended Service Set Identifier), or any other network identifier defined by Wi-Fi Alliance HotSpot2.0 may be used.

In some embodiments both ANDSF and cellular network can be used together to provide information in a single cellular network. If the UE receives information from both sources, information received through cellular network takes precedence over ANDSF information due to the fact that cellular network information is more up-to-date and reflects the current status better than more static ANDSF information.

Reference is made to FIG. 5 which shows a method of an embodiment.

In step S1, one or more rules are signalled to the UE. The rules may be any one or more rules for how UE utilizes WLAN accesses when there is a bar on the UE and/or a connection is rejected. The rules may be any one or more of the previously described rules.

In step S2, a list of one or more WLAN network identifiers or the like are signalled to the UE. This step may take place before, after or at the same time as step S1. The list of one or more WLAN network identifiers may be signalled with one or more rules.

In step S3, a condition which triggers a rule occurs. The UE may for example be unable to make a RRC connection or an RRC connection request is rejected.

In step S4, the UE will in response to the triggering of the rule, access one of the networks included in the list of WLAN identifiers.

It should be appreciated that those parts of the method performed by the UE may be performed at least partially by an apparatus thereof comprising at least one memory, at least one processor and executable computer program code.

Embodiments have been described in relation to WLAN and 3GPP networks. It should be appreciated that these two networks are by way of example only. In some embodiments, other cellular communication networks may be used instead of 3GPP networks. Other suitable wireless local networks can be used instead of the WLAN network. Some embodiments may be used with any two or more suitable networks.

The required data processing apparatus and functions of an apparatus in a network element and/or a mobile device for the causing configuration, signalling, determinations, and/or control of measurement and reporting and so forth may be provided by means of one or more data processor. The described functions may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

An appropriately adapted computer program code product or products may be used for implementing the embodiments, when loaded or otherwise provided on an appropriate data processing apparatus. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments may be practiced in various components such as integrated circuit modules. The design of integrated circuits is by and large an automated process. Complex and powerful tools are available for converting a logic level design into a semiconductor circuit design ready to be formed on a semiconductor substrate.

It is noted that whilst embodiments have been described in relation to HSUPA, similar principles can be applied to any other communication system. Therefore, although certain embodiments were described above by way of example with reference to certain exemplifying architectures for wireless networks, technologies and standards, embodiments may be applied to any other suitable forms of communication systems than those illustrated and described herein. Whilst the above embodiments have been described in relation to uplink communications, some embodiments may be used in downlink communications.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. For example, a combination of one or more of any of the other embodiments previously discussed can be provided. All such and similar modifications of the teachings of this invention will still fall within the scope of this invention as defined in the appended claims.

1. A method comprising;
causing a user equipment to use one or more wireless local area networks based on cellular network information for a wireless cellular network indicating that a user equipment has restricted access to said wireless cellular network.

2. A method as claimed in claim 1, wherein said restricted access comprises at least one of barring of said user equipment and rejection of a connection attempt.

3. A method as claimed in claim 2, wherein said barring comprises at least one of barring of said user equipment for data, signalling, emergency calls and priority calls.

4. A method as claimed in claim 2, wherein said rejection comprises rejection of a radio resource control connection.

5. A method as claimed in claim 1, comprising using one or more rules defining how said user equipment is to behave in response to restricted access to said wireless cellular network.

6. (canceled)

7. A method as claimed in claim 5, wherein the one or more rules are dependent on a subscription class of said user equipment.

8. (canceled)

9. A method as claimed in claim 5, wherein said access network discovery and selection function policy comprises at least one access network discovery and selection value associated with restricted access to said wireless cellular network.

10. A method as claimed in claim 5, comprising receiving at least part of one or more rules in one or messages from said cellular network.

11. A method as claimed in claim 1, comprising using in said user equipment information about one or more wireless local area networks to select the one or more wireless local area network to be used by said user equipment.

12. A method as claimed in claim 1, comprising providing to said a user equipment information about one or more wireless local area networks which said user equipment is permitted to use when said user equipment has restricted access to a wireless cellular network.

13. (canceled)

14. A computer program product comprising computer executable code which when run causes the method of claim 1 to be performed.

15. An apparatus comprising at least one processor and at least one memory including computer code for one or more programs, the at least one memory and the computer code configured, with the at least one processor, to cause the apparatus at least to: cause a user equipment to use one or more wireless local area networks based on cellular network information for a wireless cellular network indicating that a user equipment has restricted access to said wireless cellular network.

16. An apparatus as claimed in claim 15, wherein the restricted access comprises at least one of barring of said user equipment and rejection of a connection.

17. An apparatus as claimed in claim 16, wherein the barring comprises at least one of barring of said user equipment for data, signalling, emergency calls and priority calls.

18. An apparatus as claimed in claim 16, wherein the rejection comprises rejection of a radio resource control connection.

19. An apparatus as claimed in claim 15, wherein the at least one memory and the computer code are be configured, with the at least one processor, to cause the apparatus to use one or more rules defining how said user equipment is to behave in response to restricted access to said wireless cellular network.

20. (canceled)

21. (canceled)

22. An apparatus as claimed in claim 19, wherein one or more rules are dependent on a subscription class of said user equipment

23. An apparatus as claimed in claim 19, wherein the at least one memory and the computer code are configured, with the at least one processor, to cause the apparatus to receive least part of one or more rules as part of one or more access network discovery and selection function policies.

24. An apparatus as claimed in claim 19, wherein the at least one memory and the computer code are configured, with the at least one processor, to cause the apparatus to receive at least part of one or more rules in one or messages from said cellular network.

25. An apparatus as claimed in claim 15, wherein the at least one memory and the computer code are configured, with the at least one processor, to cause the apparatus to provide to said user equipment information about one or more wireless focal area networks which a user equipment is permitted to use when said user equipment has restricted access to a wireless cellular network.
